(19) United States
(12) Patent Application Publication
(10) Pub. No.: US 2013/0125066 A1
(43) Pub. Date: May 16, 2013

(54) Adaptive Area Cursor

(71) Applicants: Christian Klein, Duvall, WA (US); Peter D. Rosser, Kirkland, WA (US)

(72) Inventors: Christian Klein, Duvall, WA (US); Peter D. Rosser, Kirkland, WA (US)

(73) Assignee: MICROSOFT CORPORATION, Redmond, WA (US)

(21) Appl. No.: 13/295,546

(22) Filed: Nov. 14, 2011

(51) Int. Cl. G06F 3/048

(52) U.S. Cl. 715/862

(57) ABSTRACT

Described is a technology by which a user's cursor movement is assisted to help select elements of a user interface that may be otherwise difficult to target. An area cursor is provided that may intersect more than one element. If so, a computation result (e.g., a percentage) is computed for each intersected element that is based upon intersection with the cursor and a total size of the element; the largest percentage intersection is selected. The computation (e.g., intersected area divided by total element area) favors smaller elements as they have a smaller area in the denominator. Also described is changing the cursor size to help hit elements and/or based upon one or more criteria. Still further described is determining the total size of an element based upon weighting, in addition to or instead of the element's actual size. Weighting may be based upon one or more criteria.

### BACKGROUND

In systems that use a low-precision pointing device such as a game controller, joystick or air gesture (e.g. depth-camera based) control to maneuver a cursor, the user interface (UI) ideally accommodates this lack of precision with large UI elements and/or sparse layouts in which the elements are spaced relatively far apart from one another. However, UIs having these layout constraints are often not available or realistic. For example, a system may render user interfaces that include UI elements that are of mixed sizes and/or are in close proximity to one another, such as web pages that were originally designed for a high-precision pointing device (such as a mouse, trackball or stylus).

Moreover, users operating even relatively high-precision input devices can have difficulty navigating among UI elements when the user is at a distance from the elements, such as when browsing on a large television screen with the cursor accordingly enlarged for visibility. Given the vast amount of existing web pages and other content that is available to users, it is not feasible to have web page authors and other user interface developers redesign their user interfaces for low-precision input devices and/or interaction at a relatively far distance.

In these situations, it is desirable to provide assisted targeting in some form. While existing solutions such as “magnetic” UI controls and area cursors (that cover a larger area than a conventional cursor) partially address this challenge, they still do not work particularly well in arbitrary UI layouts such as web pages.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which a cursor is positioned among elements of a user interface based upon user-controlled cursor movement. The cursor, which may be a two-dimensional area cursor or three-dimensional cursor, may intersect more than one element; (elements that are too small or are not intended to be selectable, may be excluded). In the event that the cursor intersects a plurality of elements, a computation result is computed for each intersected element that is based upon a first size that corresponds to intersection of that element with the cursor and a second size that corresponds to a total size of the element to provide a plurality of computation results for the plurality of intersected elements. The plurality of computation results determines user selection intent with respect to which of the plurality of intersected elements to target. By way of a non-limiting example, the computation result for each element may correspond to an intersection percentage value comprising an area of the element that intersects with the area cursor divided by a total area of the element; the element with the largest intersection percentage value is targeted.

In one aspect, the size of the cursor may be modified based upon at least one growth criterion. For example, the size of the cursor may be modified until at least one element intersects with the cursor (to at least a sufficient amount), or until at least two elements intersect with the cursor (to at least a sufficient amount). As another example, the size of the cursor may be modified until the cursor encompasses a predetermined amount of an element. In one aspect, the area cursor's size may be modified based upon one or more criteria, including cursor movement speed, density of the elements, distance from a user to the displayed program elements, and/or user characteristics.

In one aspect, the total size of an element may comprise a weighted size in addition to or instead of the element's actual size. Weighting may be based upon one or more criteria, including relative importance to a task, past user behavior and/or context of the page elements.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram showing example components configured to provide an adaptive area cursor to assist users in navigating among elements according to one example implementation.

FIGS. 2A-2C comprise representations of how an adaptive area cursor may be navigated to elements and used for selection according to various example implementations.

FIG. 3 is a flow diagram representing example steps that may be taken to process navigation of an adaptive area cursor according to one example implementation.

FIG. 4 is a flow diagram representing example steps that may be taken to determine which element to select for an adaptive area cursor according to one example implementation.

FIG. 5 is a block diagram representing an example computing environment, in the form of a gaming system, into which aspects of the subject matter described herein may be incorporated.

### DETAILED DESCRIPTION

Various aspects of the technology described herein are generally directed towards an adaptive area cursor that assists users in targeting and selecting user interface (UI) elements, (also referred to as UI controls or objects), particularly in a UI that mixes large and small elements. In one implementation, an adaptive area cursor is used for targeting elements in a way that allows the user to interact with a UI element by positioning the cursor nearby and/or overlapping (not necessarily fully on) a desired element. In situations where the area cursor overlaps more than one element, the target is chosen based on an adaptive area cursor mechanism that generally favors elements that are more difficult to target (that is, compared to using a traditional cursor). For example, the mechanism may choose the element based upon a percentage of each element's area that intersects with the cursor's area.

It should be understood that any of the examples herein are non-limiting. Indeed, while two-dimensional examples are described, the technology applies to three dimensional regions. Further, the technology may work with any computing device such as a gaming system, personal computer, smartphone and/or tablet. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used in various ways that provide benefits and advantages in computing and computer input in general.

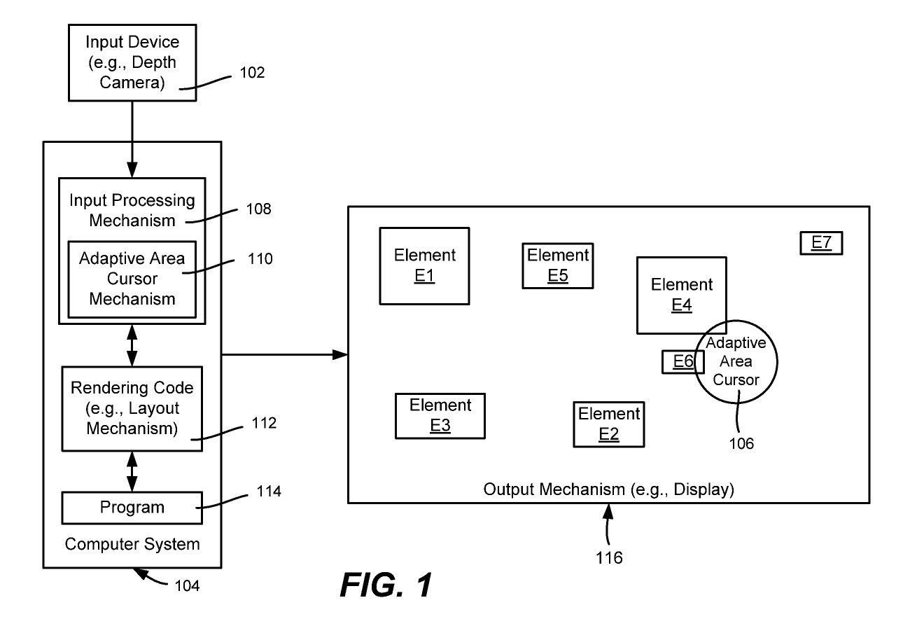

FIG. 1 shows a block diagram in which an input device 102, such as a depth camera, is used as input to a computer system 104, including to control an adaptive area cursor 106. As will be understood, any human interface device that is capable of controlling a cursor may benefit from the technology described herein, including a game controller, joystick, mouse or other pointing device, stylus, finger and so forth. Thus, the input device 102 represents any such devices.

In the example of FIG. 1, the input signals from the input device 102 are processed by an input processing mechanism 108, including an adaptive area cursor mechanism 110, to provide and use an adaptive area cursor as described herein. For example, the input processing mechanism 108 may be part of an operating system, such as a list context available as a service, useable by any program including applications and other operating system components, and may be basically transparent to those programs. In this example, the input processing mechanism 108 may communicate with rendering code 112 in the form of a layout mechanism to determine how to adapt the adaptive area cursor and perform hit testing in view of UI elements E1-E7 arranged by a program 114. Alternatively, a program may provide the input processing mechanism 108 with a collection of the areas of interest (e.g., the positions and sizes of its elements), such as via an API call or via another suitable interface. Still further, a program such as a browser may perform its own cursor handling, including area adaptation and hit testing as described herein. Thus, FIG. 1 shows only one non-limiting example.

As represented in FIG. 1, the adaptive area cursor 106 is shown as being visible among the UI elements E1-E7 on an output mechanism 116. As can be readily appreciated, a lesser or greater number of elements than those exemplified may be present, and the elements may be within a program window, or located on a single viewing region.

The adaptive area cursor 106 is shown in FIG. 1 as a circle, however any other shape may be used for area-based detection, including other geometric shapes such as rectangles and triangles, shapes such as arrows, hourglasses, crosshairs, and other shapes including renderings of a human hand, (which may be helpful to users in gesture-based control because it gives the user some additional perspective). In three-dimensional (volumetric) interactive space, a volumetric cursor shape such as a sphere may be used. The size of the area cursor may be fixed or may vary, and for example may be determined in various ways, including by speed of cursor movement, density of displayed elements, based upon user characteristics (e.g., the size of a user's finger or palm), the distance from a user to the displayed program elements (which may be known via depth camera data), user-specified preference information, and so forth.

The adaptive area cursor 106 may be visible (solid or translucent) in some way, or invisible in terms of the area covered (possibly with a visible representation of a cursor to assist the user navigation; note that a touch screen scenario may have no visible cursor representation at all). This facilitates compatibility with arbitrary existing UI layouts and cursor visualizations. For example, an arrow (that changes to a pointing hand when hovering) may be visible to the user as the cursor; however an invisible circle centered at or near the tip of the arrow/pointer finger may enlarge the area that the arrow tip effectively covers, thereby providing an area cursor. Such a “regular” cursor may be modified in some way to indicate that targeting assistance is active, such as to change its color, (particularly if the adaptive area cursor is invisible). Further, as will be understood, the adaptive area cursor can adapt its size, and this changed size also may or may not be visible or invisible to users. Thus, an adaptive area cursor may be visible, fully invisible (e.g., possibly with a “regular” cursor or the like represented in any suitable way), or partly visible and partly invisible to users.

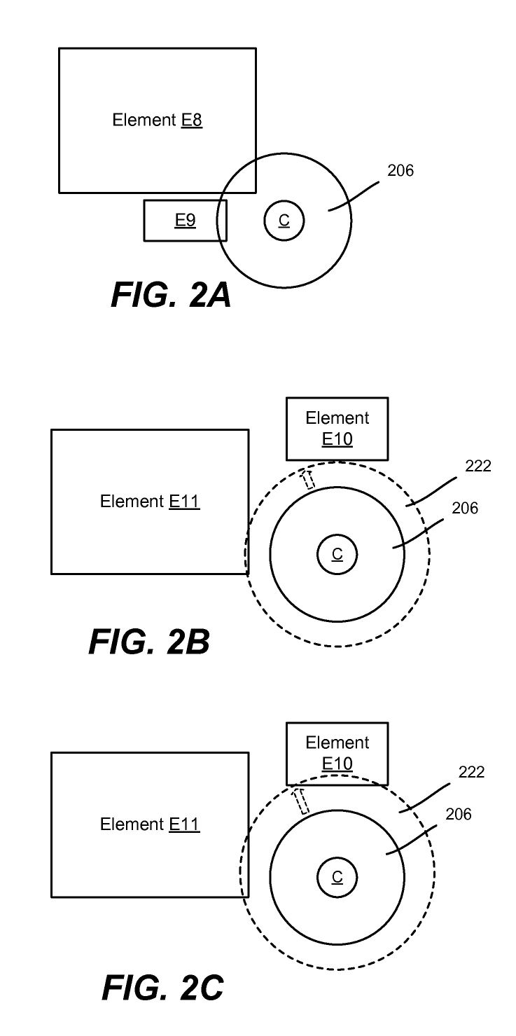

FIGS. 2A-2C show various ways in which an adaptive area cursor may operate to assist a user in targeting an element. In the example of FIG. 2A, the adaptive area cursor 206 is centered at point C (which may be as small as one pixel), and as positioned by a user intersects two elements E8 and E9.

As can be seen in FIG. 2A, an area cursor may overlap more than one UI element at the same time. In some known systems, a simple area cursor is allowed to target multiple objects at the same time (e.g. to “paint” a selection across items in a list). In other systems that have a single focus, one of the objects is chosen based on the element that the cursor overlaps the most. With such a single focus system given the example of FIG. 2A, the larger element E8 is targeted (often incorrectly with respect to the user's intent) simply because more of the cursor's surface area overlaps with that element, that is, element E8 has the most pixels overlapped by the cursor.

As described herein, in contrast to such other systems, the element is chosen based upon a consideration of which element the user more likely intended to target. In one implementation, the element E9 is chosen based on the percentage of the element's surface area that intersects with the area of the cursor 206. This is true even though in FIG. 2A the absolute overlap area of the element E9 is not as large as the absolute overlap area of the element E8; rather, the smaller element E9 is targeted because a higher percentage of its surface area intersects with the cursor 206, compared to the percentage of element E8's surface area that intersects with the cursor 206. In this way, small elements that are near larger elements receive a more significant degree of targeting assistance and hence are relatively easier to select. As a more specific example, small text hyperlinks or other objects near larger category headings and/or images on a web page are easily selectable, without any visual reformatting of the page.

It should be noted, however, that the adaptive area cursor mechanism 110 may include logic that excludes certain elements. For example, some pages include one pixel-by-one pixel elements that are used for tracking purposes and the like, but are not intended to be selected. Such small elements may be ignored (filtered out) in the adaptive area cursor mechanism's selection determination, as they are one-hundred percent covered if overlapped at all, but not intended to be selectable. This filtering may be based on the size or type of a UI object, or based on some other form of data related to the object.

As can be seen, a percentage-based determination assists in the targeting of smaller elements, e.g., for each element the percentage equals the number of intersected pixels divided by that element's total number of pixels. The percentage comparison also works with more than two elements. Moreover, some threshold may be used instead of automatically choosing the greatest percentage, e.g., for two elements, at least a sixty percent versus forty percent intersection threshold may be needed, otherwise a secondary mechanism (e.g., the largest intersected number of pixels) may be used. Any such threshold may vary based upon factors such as distance of the user from the display (which may be known via depth camera data), size and/or separation of the elements (e.g., two smaller elements may have a threshold closer to fifty percent), size of the area cursor, and so forth. Further, an exact percentage may not be used as the final value to compare, e.g., any or all computed values may be modified by a multiplication factor, an added or subtracted value, and/or the like. Computation of these factors may be completed locally, on the machine receiving the inputs, or remotely, through communication with another machine over a computer network, e.g. the internet.

In another aspect, elements may be weighted differently instead of by their actual visible size, that is, an element's total size used in the computation may not be its actual visible size but may be resized based upon one or more criteria. For example, an element's weighted size may be based upon its relative importance to a task. As a more particular example, a selection button that is known to be disabled (e.g., by returning information that it did not handle click) may be given zero or at least far less weight (e.g., in a percentage model by enlarging its weighted size relative to its actual size, or changing the percentage needed to be considered selected) than an enabled button nearby, on the prediction that a user that moves the cursor towards the two buttons is more likely intending to select the enabled one. Past user behavior (for a given user or observed among a group of users) may also be used as a criterion to change the relative importance, e.g., more users click on a popular link in a list of links than one next to it, and/or tend to navigate in an inferred order, and so forth. Sponsored links also may be given more weight.

Still further, the context of the page elements may be used to weight an element with respect to a user's intent to select an element. For example, a page's Tab order (the order to which links are navigated if the user clicks the Tab key) may be used to effectively weight one element relative to another element. Consider a user filling out a form, in which the user has entered his or her street address and has moved the cursor near a next entry in the form to enter his or her city. It may be observed that the user is (or most users are) intending to move to the city data entry element rather than another element, such as one already completed, or one that is not related to data entry. Thus, additional weight may be given to the city entry element (e.g., making the element effectively smaller so that its intersected percentage is greater).

FIG. 2B shows another example, in which the adaptive area cursor 206 is near two elements, but not intersecting either. In this example, the adaptive area cursor 206 modifies (grows) its area (represented by the larger, dashed-line circle 222 and the dashed arrow indicating direction of the modification) until an element is intersected, which in this example is the element E11. To be considered as intersecting, the intersection may need to be to at least some sufficient amount, as little as one pixel, but possibly more. Note that size modification may be accomplished by growing or shrinking the cursor area and/or by zooming the screen. A limit to the size may be applied, e.g., so that a user may intentionally position the cursor in an empty region of the screen so as to not target (e.g., hover over and change the appearance of) an element. Modification of the cursor size may be in a negative direction, e.g., to shrink the area depending on cursor movement speed and/or other factors. Note that modification of the cursor size may be limited to actual user selection of an element rather than hovering, e.g., a user needs to position the cursor and take an action (e.g., corresponding to a mouse click) to select an element before the adaptive area cursor 206 grows to locate the nearest element; (note that the underlying page may itself be a clickable element, and thus a modification size limit may be used to ensure that a user may click the page rather than always grow to reach at least one foreground element).

FIG. 2C shows an example similar to that of FIG. 2B in that the adaptive area cursor 206 adapts by growing in size, but in FIG. 2C the cursor area is enlarged until at least two elements are intersected. At this time, the percentage-based selection mechanism (or other user intent determining mechanism) may be used to determine which element to target. In this example, some minimum number of pixel intersections (which may be display dependent) may be needed before the growth stops, so that a meaningful percentage can be computed, for example. Thus, FIG. 2C represents that the area cursor grows in diameter to some extent over element E10 at least to a sufficient amount to be considered as intersecting, rather than stopping the moment that the first pixel of element E10 is reached.

Other ways of modifying the cursor size are feasible. For example, one way is to increase the area (e.g., the radius of the circle up to some maximum) until it completely encompasses one element. Another way is to use some predetermined less-than-complete encompassing percentage, e.g., enlarge (to a maximum) until the cursor intersects with seventy percent of an element.

Note that while a circular cursor may grow or shrink symmetrically, consideration may be given to non-symmetrical growth. For example, a circular cursor may become an oval by growing differently in the x- and y-axes, as may a cursor of any other shape, such as a rectangle becoming wider or taller, but not necessarily at the same rate. A cursor may grow or shrink proportional to the display screen's x- and y-dimensions or a program window's x- and y-dimensions, (or some combination thereof). Whether the user is moving the cursor in a mostly horizontal direction or mostly vertical direction may also be considered when modifying the cursor size.

Further, an adaptive area cursor may dynamically change in size based on one or more other factors or criteria. For example, UI target density may be a growth-related criterion, such that the cursor grows in size if few interactive elements are nearby. Another criterion may be the sizes of elements, e.g., do not grow (or barely grow) if two elements are large enough to each be easily selected. Yet another criterion may be the current or recent speed of cursor motion, e.g., a cursor quickly moved to a position is more likely to be imprecisely positioned by the user than if slowly moved to that position, and thus size modification (or more significant size modification than usual) may be used; for example, the radius of the circle may be increased or decreased (down to some minimum) based on the current speed of the cursor's motion. The cursor may fade out or visibly change in some other way to encourage the user to slow down. Another factor in determining size modification (e.g., whether to grow at all/how much to grow/whether to grow to one object or more) may be the type of input device being used, as may be the distance from the user to the display, if known. User preference data may be a factor.

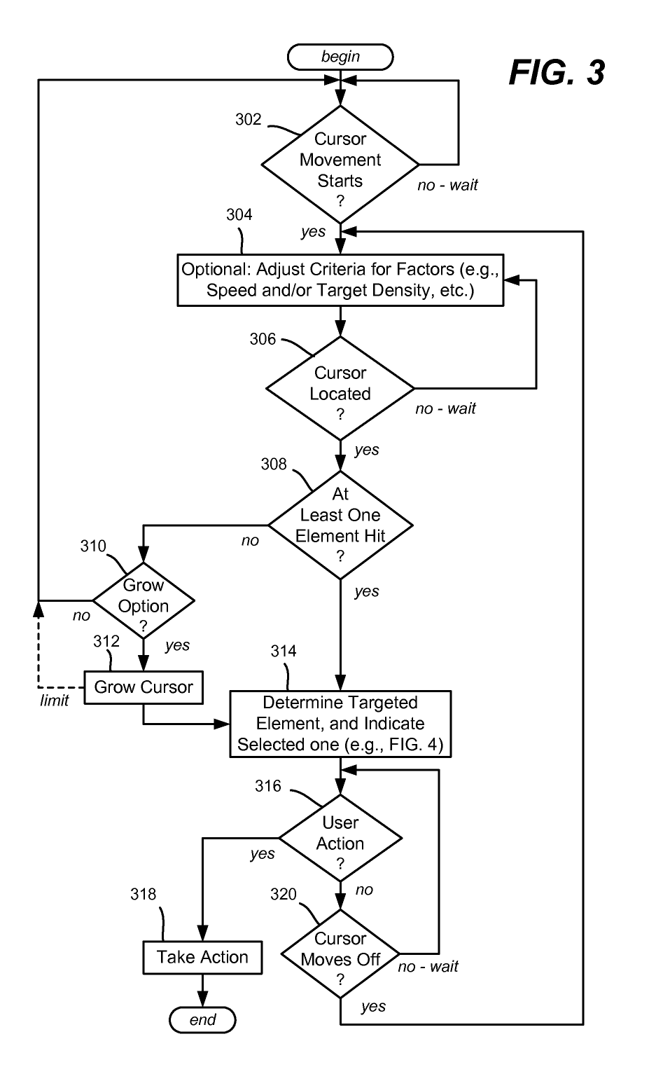

FIG. 3 summarizes assisted targeting via adaptive area cursor operation by way of a flow diagram comprising example steps of one implementation, beginning at step 302 where suitable cursor movement starts the process. Step 304 represents the optional step of adjusting parameters (e.g., element weight, cursor size) based upon the screen cursor movement speed, nearby target density, Tab order, and so forth, as described above. Step 306 represents allowing the cursor to move to a screen position.

Step 308 represents determining whether the cursor intersects at least one element; (note that this step may include the logic that excludes/filters out non-selectable elements such as one pixel-by-one pixel elements). If not, and the option to modify the cursor size (e.g., grow) is active at step 310, then the cursor area is grown at step 312 until a stopping criterion is met, e.g., one element is sufficiently hit (FIG. 2B), two elements are sufficiently hit (FIG. 2C), and so forth. If the cursor does not grow, or hits a growth limit without appropriate element intersection (the dashed line from step 312), the cursor is positioned as if the user did not target any element and returns to step 302 to await further movement.

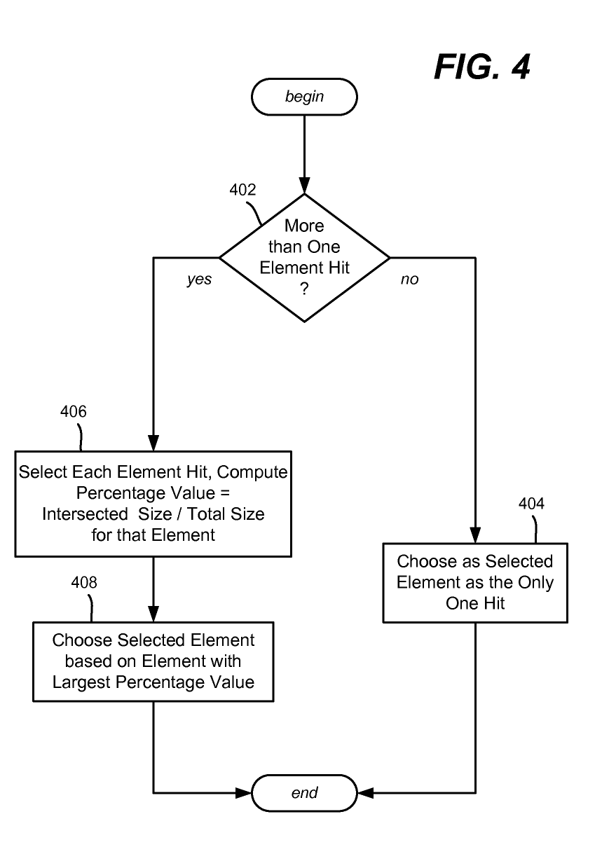

If an element is hit directly by user positioning or via cursor area modification, step 314 represents determining the targeted element, as generally described above and further exemplified in FIG. 4. Note that it is feasible to select more than one targeted element if a program desires such a scenario; indeed, the adaptive area cursor mechanism may return a ranked list of intersected elements, or a list of elements each accompanied by its intersection percentage.

In FIG. 4, step 402 represents evaluating whether more than one element is hit. If not, the element that is hit is selected at step 404. If so, step 406 determines the user intent as described above.

In the example of FIG. 4, for each element the percentage of the element that is intersected by the cursor relative to the total size of the element is computed at step 406. As described above, this total size need not equal the actual element size, but may be a weighted size value based upon one or more other criteria, such as element importance, Tab order, historical behavior of this user and/or other users, and so forth. Step 408 chooses as the selected target element the one with the largest percentage value. As a result, the adaptive area cursor may prefer (target and optionally select) a smaller element that intersects the cursor over a competing larger element, regardless of whether the larger element has more overlapped pixels.

Returning to FIG. 3, step 314 also represents indicating the selected element in some way, as appropriate. For example, in a hover scenario as described in FIG. 3, the cursor may change shape to indicate the element is selected. Note that because the cursor may be positioned between elements, the visible cursor may also be automatically moved by the system (e.g., jump to a position corresponding to the center of the selected element) to more clearly indicate that that particular chosen element is selected. In a non-hover scenario, instead of cursor movement stopping being the trigger for step 308, active user indication of selection (e.g., corresponding to a click) may trigger steps 308 and beyond.

Step 316 represents the user taking some action to select the targeted element, e.g., as if a mouse click occurred on the hovered over element, a timed hover occurred, a context menu is invoked, and so forth. If so, the action is taken as represented by step 318, e.g., to browse to a new page corresponding to a clicked link, to highlight an item, to provide a drop-down menu, and so forth as appropriate depending on the program that provided the elements. If no action is taken, the system remains in the current state until the user moves the cursor off of the element, as represented by step 320, whereby the targeting determination portion of the process waits via steps 304 and 306 until the user stops moving the cursor.

As can be seen, there is provided an adaptive area cursor that assists users in targeting elements that are otherwise difficult to target. As a result, the user no longer needs to precisely move the cursor directly over a small UI element to select that element. To this end, an area, such as a circular region may be positioned relative to (e.g., centered on) the actual cursor position, with the hit regions associated with each interactive UI element determined; (the size of the hit regions may or may not match each object's visual representation). The area of the cursor may be modified based upon the size and/or position of nearby UI objects, for example to increase the area until a stopping criterion is met, e.g., hits at least one interactive element, hits at least two or more interactive elements, encompasses an element, or the like. An element is targeted that attempts to match the user's selection intent, e.g., based upon a percentage of each element's total size (e.g., surface area or weighted area) that intersects with the cursor's size, with the highest percentage used to make the selection.

### Example Operating Environment

It can be readily appreciated that the above-described implementation and its alternatives may be implemented on any suitable computing device, including a gaming system, personal computer, tablet, smartphone and/or the like. For purposes of description, a gaming (including media) system is described as one example operating environment hereinafter.

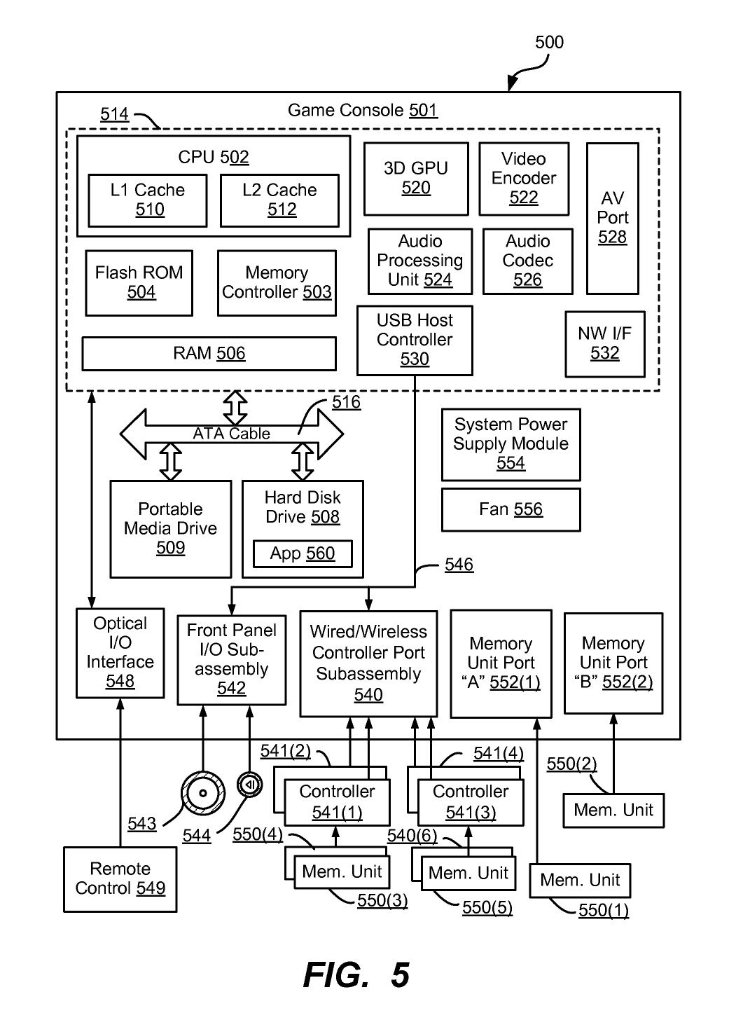

FIG. 5 is a functional block diagram of gaming and media system 500 and shows functional components in more detail. Console 501 has a central processing unit (CPU) 502, and a memory controller 503 that facilitates processor access to various types of memory, including a flash Read Only Memory (ROM) 504, a Random Access Memory (RAM) 506, a hard disk drive 508, and portable media drive 509. In one implementation, the CPU 502 includes a level 1 cache 510, and a level 2 cache 512 to temporarily store data and hence reduce the number of memory access cycles made to the hard drive, thereby improving processing speed and throughput.

The CPU 502, the memory controller 503, and various memory devices are interconnected via one or more buses (not shown). The details of the bus that is used in this implementation are not particularly relevant to understanding the subject matter of interest being discussed herein. However, it will be understood that such a bus may include one or more of serial and parallel buses, a memory bus, a peripheral bus, and a processor or local bus, using any of a variety of bus architectures. By way of example, such architectures can include an Industry Standard Architecture (ISA) bus, a Micro Channel Architecture (MCA) bus, an Enhanced ISA (EISA) bus, a Video Electronics Standards Association (VESA) local bus, and a Peripheral Component Interconnects (PCI) bus also known as a Mezzanine bus.

In one implementation, the CPU 502, the memory controller 503, the ROM 504, and the RAM 506 are integrated onto a common module 514. In this implementation, the ROM 504 is configured as a flash ROM that is connected to the memory controller 503 via a Peripheral Component Interconnect (PCI) bus or the like and a ROM bus or the like (neither of which are shown). The RAM 506 may be configured as multiple Double Data Rate Synchronous Dynamic RAM (DDR SDRAM) modules that are independently controlled by the memory controller 503 via separate buses (not shown). The hard disk drive 508 and the portable media drive 509 are shown connected to the memory controller 503 via the PCI bus and an AT Attachment (ATA) bus 516. However, in other implementations, dedicated data bus structures of different types can also be applied in the alternative.

A three-dimensional graphics processing unit 520 and a video encoder 522 form a video processing pipeline for high speed and high resolution (e.g., High Definition) graphics processing. Data are carried from the graphics processing unit 520 to the video encoder 522 via a digital video bus (not shown). An audio processing unit 524 and an audio codec (coder/decoder) 526 form a corresponding audio processing pipeline for multi-channel audio processing of various digital audio formats. Audio data are carried between the audio processing unit 524 and the audio codec 526 via a communication link (not shown). The video and audio processing pipelines output data to an A/V (audio/video) port 528 for transmission to a television or other display. In the illustrated implementation, the video and audio processing components 520, 522, 524, 526 and 528 are mounted on the module 514.

FIG. 5 shows the module 514 including a USB host controller 530 and a network interface (NW I/F) 532, which may include wired and/or wireless components. The USB host controller 530 is shown in communication with the CPU 502 and the memory controller 503 via a bus (e.g., PCI bus) and serves as host for peripheral controllers 534. The network interface 532 provides access to a network (e.g., Internet, home network, etc.) and may be any of a wide variety of various wire or wireless interface components including an Ethernet card or interface module, a modem, a Bluetooth module, a cable modem, and the like.

In the example implementation depicted in FIG. 5, the console 501 includes a controller support subassembly 540, for supporting four game controllers 541(1)-541(4). The controller support subassembly 540 includes any hardware and software components needed to support wired and/or wireless operation with an external control device, such as for example, a media and game controller. A front panel I/O subassembly 542 supports the multiple functionalities of a power button 543, an eject button 544, as well as any other buttons and any LEDs (light emitting diodes) or other indicators exposed on the outer surface of the console 501. The subassemblies 540 and 542 are in communication with the module 514 via one or more cable assemblies 546 or the like. In other implementations, the console 501 can include additional controller subassemblies. The illustrated implementation also shows an optical I/O interface 548 that is configured to send and receive signals (e.g., from a remote control 549) that can be communicated to the module 514.

Memory units (MUs) 550(1) and 550(2) are illustrated as being connectable to MU ports “A” 552(1) and “B” 552(2), respectively. Each MU 550 offers additional storage on which games, game parameters, and other data may be stored. In some implementations, the other data can include one or more of a digital game component, an executable gaming application, an instruction set for expanding a gaming application, and a media file. When inserted into the console 501, each MU 550 can be accessed by the memory controller 503.

A system power supply module 554 provides power to the components of the gaming system 500. A fan 556 cools the circuitry within the console 501.

An application 560 comprising machine instructions is typically stored on the hard disk drive 508. When the console 501 is powered on, various portions of the application 560 are loaded into the RAM 506, and/or the caches 510 and 512, for execution on the CPU 502. In general, the application 560 can include one or more program modules for performing various display functions, such as controlling dialog screens for presentation on a display (e.g., high definition monitor), controlling transactions based on user inputs and controlling data transmission and reception between the console 501 and externally connected devices.

The gaming system 500 may be operated as a standalone system by connecting the system to high definition monitor, a television, a video projector, or other display device. In this standalone mode, the gaming system 500 enables one or more players to play games, or enjoy digital media, e.g., by watching movies, or listening to music. However, with the integration of broadband connectivity made available through the network interface 532, gaming system 100 may further be operated as a participating component in a larger network gaming community or system.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method performed at least in part on at least one processor comprising:
positioning a cursor among elements of a user interface based upon user-controlled cursor movement, and
determining whether the cursor intersects a plurality of elements, and if so:
computing for each intersected element a computation result that is based upon a first size that corresponds to intersection of that element with the cursor and a second size that corresponds to a total size of that element to provide a plurality of computation results for the plurality of intersected elements, and
using the plurality of computation results to determine user selection intent with respect to which of the plurality of intersected elements to target.

2. The method of claim 1 wherein each element corresponds to a two-dimensional area and wherein the cursor is a two-dimensional area cursor, and wherein the computation result for each element corresponds to a percentage value comprising an area of the element that intersects with the area cursor divided by a total area of the element.

3. The method of claim 1 wherein the computation result for each element corresponds to an intersection percentage value comprising an area or volume of the element that intersects with an area or volume of the cursor divided by a total area or volume of the element, and wherein using the plurality of computation results to determine user selection intent with respect to which of the plurality of intersected elements to target comprises selecting the element corresponding to the largest percentage value.

4. The method of claim 1 wherein the total size of the element comprises a weighted size, and further comprising, computing the weighted size based upon at least one weighting criterion.

5. The method of claim 1 wherein the total size of the element comprises a weighted size, and further comprising, computing the weighted size based upon an actual size of the element and at least one weighting criterion.

6. The method of claim 1 further comprising modifying a size of the cursor based upon at least one growth criterion.

7. The method of claim 1 further comprising modifying a size of the cursor until at least one element intersects with the cursor to at least a sufficient amount, or modifying a size of the cursor until at least two elements intersect with the cursor, each intersection to at least a sufficient amount.

8. The method of claim 1 wherein determining whether the cursor intersects a plurality of elements comprises excluding any element that is too small to be a selectable element or is otherwise identified as not being a selectable element.

9. The method of claim 1 further comprising modifying a size of the cursor until the cursor encompasses a predetermined amount of an element.

10. A system comprising, an adaptive area cursor mechanism configured to process data corresponding to a location of a user interface area cursor, the adaptive area cursor mechanism further configured to target one element when the area cursor intersects a plurality of elements, including to select a targeted element based upon values computed for the plurality of intersected elements, each value associated with an intersected element of the plurality and corresponding to a cursor-element intersection size relative to a total element size for that element.

11. The system of claim 10 wherein the adaptive area cursor mechanism selects the targeted element based upon which value is largest among the values.

12. The system of claim 10 wherein the adaptive area cursor mechanism is incorporated into a gaming system, a set-top box, a tablet, a personal computer, or a mobile device.

13. The system of claim 10 wherein the adaptive area cursor mechanism is further configured to obtain data corresponding to positions and actual sizes of the elements from a layout mechanism.

14. The system of claim 10 wherein the adaptive area cursor mechanism is configured to modify the area cursor's size to intersect with at least one element.

15. The system of claim 10 wherein the adaptive area cursor mechanism is configured to modify the area cursor's size based upon one or more criteria, including cursor movement speed, density of the UI elements, distance from a user to the displayed program elements, or user characteristics, or any combination of cursor movement speed, density of the elements, distance from a user to the displayed program elements, or user characteristics.

16. The system of claim 10 wherein the adaptive area cursor mechanism is configured to modify the total element size for at least one element to correspond to a weighted size based upon one or more criteria, including relative importance to a task, past user behavior or context of the page elements, or any combination of a weighted size based upon one or more criteria, including relative importance to a task, past user behavior or context of the page elements.

17. The system of claim 10 wherein the adaptive area cursor mechanism is configured to compute the values for the plurality of intersected elements when the area cursor is hovering over at least one element.

18. The system of claim 10 wherein the adaptive area cursor mechanism is configured to compute the values for the plurality of intersected elements when the area cursor is activated by a user action corresponding to an attempt to select an element.

19. One or more computer-readable media having computer-executable instructions, which when executed perform steps, comprising:
detecting intersection between an area cursor and at least one element of a user interface; and
if the intersection is with a single element, selecting that element as a targeted element; and
if the intersection is with more than one element, determining an intersection percentage value indicative of what percentage of each intersected element intersects with the area cursor, and selecting as a targeted element the element having the largest intersection percentage value.

20. The one or more computer-readable media of claim 19 having further computer-executable instructions comprising, growing the area cursor until a predetermined number of elements are intersected, each intersection to a sufficient amount.
